(19) United States
(12) Patent Application Publication
(10) Pub. No.: US 2008/0312877 A1
(43) Pub. Date: Dec. 18, 2008

(54) Method and Device for Functional Checking of a Field Device Before the Comissioning Thereof

(76) Inventors: Dieter Keese, Wahlsburg (DE); Harry Plotzki, Gottingen (DE); Frank Buhl, Rosdorf (DE); Karl-Heinz Rackebrandt, Adelebsen (DE); Andreas Thone, Norten-Hardenberg (DE); Jorg Herwig, Kandern (DE); Rolf Merte, Heidelberg (DE); Peter Riegler, Gottingen (DE)

Correspondence Address: BUCHANAN, INGERSOLL & ROONEY PC, POST OFFICE BOX 1404, ALEXANDRIA, VA, 22313-1404, US

(21) Appl. No.: 11/658,271

(22) PCT Filed: Jul. 22, 2005
(86) PCT No.: PCT/EP2005/007997

§ 371 Date: Oct. 24, 2007

(30) Foreign Application Priority Data
Jul. 30, 2004 (DE) 102004037064.8

(51) Int. Cl. G21C 17/00

(52) U.S. Cl. 702/183

(57) ABSTRACT

A method and device is disclosed for functional checking of a field device in a field bus system before the commissioning thereof. After installation and connection of the field device, a functional checking algorithm is carried out with regard to meeting relevant connection parameters, whereby commissioning of the field device is permitted when all connection parameters to be checked by the functional checking algorithm are within permitted ranges.

The present invention relates to a method and to a device for functional checking of a field device in a field bus system, specifically before the commissioning thereof. The invention further relates to a related software program product and to a field device comprising the said device for functional checking.

Field devices that serve to measure or influence process variables are increasingly being used in the technical field of automation technology. Examples of such field devices are level gages, flowmeters, pressure gages, temperature gages and the like which measure the corresponding process variables of material flow, level, pressure and temperature. So-called actors serve to influence said process variables; as valves said actors control the flow of a liquid in a section of piping for instance.

As a rule the field devices are connected via a data bus to a control system which controls the execution of the entire process or enables direct access to the individual field devices in order to operate, parameterize or configure them. By means of the direct access, parameters can be changed on the field device or special diagnostics functions can be called up during operation. In addition to access via the control system, occasional access is also possible via a portable handheld operating device or the like. The measured values of the various process variables are analyzed or monitored in the control system and the corresponding actors are actuated. Data is transmitted between the field device and the control system in conformance with the known international standard for field buses, in particular Hart Foundation Fieldbus, Profibus, CAN. Besides a cable connection, a radio link between the field device and the control system is also conceivable.

In practice, the majority of problems that arise during the operation of a field device can be attributed to errors before the field device was commissioned. A typical error is, for instance, that the measuring range of the field device is incorrectly set up, that is to say does not correspond to the required measuring range. In the case where the field device is a flowmeter, the latter can be set up for far greater flow rates of the flowing medium than the actual flow rate prevailing within the section of piping. Also typical is an incorrect set-up of the system in which the field device is to be installed. In the case of a flowmeter, for instance, the installation location may be sited too close to a bend in the pipe, which is contrary to the device specification. Another typical error is also improper installation, that is to say—to continue with the example of the flowmeter—that the device is installed askew, i.e. not with the envisaged orientation. The effects of all these and similar errors range from unreliability of the measured values through to irreparable damage to the field device itself.

To avoid the sources of error set out above, the generally known prior art provides the person skilled in the art with design tools to enable him to determine a suitable field device for his specific application. It is thus possible, for instance, to determine the field device (flowmeter) suitable for this purpose from the range of available field devices on the basis of relevant connection parameters, such as pipe diameter or flow rate.

Referring to the manual for the field device, the person skilled in the art also has the opportunity before commissioning the field device, i.e. in the course of installation, to determine the system requirements for said field device and to carry out appropriate checks. However, the actual performance of said checks and the identification of errors remains dependent on the competent expertise of the person skilled in the art.

Practice has shown that the above-described measures before commissioning a field device are not sufficient to effectively preclude the potential sources of error. In the case where errors that affect the functionality of the field device were actually made before the field device was commissioned, the measures known in the prior art cannot prevent the field device actually being put into operation. In the method according to the prior art set out above, the field device can thus be operated without the use of any design tools or manuals at all. As a rule, therefore, the errors resulting from the causes described in the introduction are only noticed by the conventional diagnostics functions during operation of the field device. Since the system containing the field device is however already in operation at this time, a subsequent exchange or repair entails increased costs.

The object of the present invention is therefore to create a method and a device for functional checking of a field device in a field bus system, before the commissioning thereof, which make it possible to reliably avoid any impairment in the functioning of the field device as a result of non-compliance with the required relevant connection parameters.

The object is achieved starting from a method according to the preamble of claim 1 in conjunction with the characterizing features thereof. In relation to the device, the object is achieved by claim 11. With respect to a field device for a field bus system, the object is achieved according to claim 19. Finally, claim 20 relates to a software program product for achieving the object of the invention.

The invention includes the process teaching that, after installation and connection of the field device, an implemented functional checking algorithm is carried out with regard to meeting relevant connection parameters, whereby commissioning of the field device is only permitted when all connection parameters to be checked by the functional checking algorithm are within permitted ranges.

One advantage of the solution according to the invention is that after installation, the field devices cannot be put into operation without checking for typical errors caused by the relevant connection parameters. This avoids expensive subsequent system downtimes for repairing or exchanging the field devices integrated therein. According to the invention, the functional checking for the correctness of the connection parameters is performed neither before nor during the fitting of the field device, but rather after it has been fitted, that is to say at a time at which the connection parameters are already applied to the field device.

In the context of the present invention, a connection parameter may be, in the case of a flowmeter for instance, the correct installation on the inflow and outflow side, in that it is checked whether an electrical contact is present here. Furthermore, the connection parameter of a sufficiently long inflow for a flowmeter can be detected by determining impermissible turbulence and flow rates by means of suitable sensor means. In the context of the present invention therefore, all values that indicate the correct dimensioning and the correct installation of the field device are connection parameters. An electronic functional checking unit arranged in the field device for carrying out the functional checking algorithm should preferably determine at the beginning of the functional checking algorithm whether the field device is actually installed and correctly connected and thus operationally ready. This measure enables a higher degree of reliability for the functional checking according to the invention, since the condition at the outset of the functional checking is also determined as part of the functional checking algorithm. The functional checking algorithm then subsequently checks the remaining relevant connection parameters.

It is advantageous if the permitted ranges of the connection parameters defined during the manufacturing process of the field device are stored as nominal values in a storage unit assigned to the electronic functional checking unit. It is not necessary for the required connection parameters to be stored in a modifiable manner here, since they are permanently associated with the field device and consequently cannot change.

It is advantageous if the electronic functional checking unit likewise retrievably stores the result of the functional checking algorithm in the storage unit of the field device. It is then possible to establish at a later time whether the functional checking algorithm delivered the desired results during commissioning of the field device or not and, where relevant, what connection parameters lie outside the permitted defined ranges.

According to a further measure for enhancing the invention, it is provided that, if the result of the functional checking algorithm is negative, the electronic functional checking unit notifies the user via appropriate display means about the incorrect connection parameters that led to release of the field device being withheld. In the simplest case, the display means may be designed in the form of binary illuminated indicators. However, in order to obtain meaningful information, an alphanumeric display should preferably be used for this purpose. In this case, the display means designed in this way can also output additional help information for rectifying the incorrect connection parameters, in order to facilitate interpretation of the results of the functional checking algorithm by the user and provide concrete information about specific ways of rectifying the errors.

According to another invention-enhancing measure, it is proposed that the electronic functional checking unit is connected to input means that can be operated manually by the user, the operation of which in the case where the result of the functional checking algorithm is negative initiates a manual release of the field device in order to nevertheless commission said field device. Such an input means may be designed, for instance, in the form of a menu item that can be confirmed on a graphical user interface. This decision of the user is also preferably stored in the field device and thereby documented.

The electronic functional checking algorithm can have, for instance, menu-driven dialog means for prompting the user to enter the operative connection parameters in order to execute the functional checking algorithm in a user-dependent manner. Alternatively or additionally, it is however also possible that the electronic functional checking unit has integrated sensor means which determine the operative connection parameters—that can be measured by sensors—in order to execute the functional checking algorithm in a user-independent manner in this case.

Further invention-enhancing measures will be described below together with the description of a preferred exemplary embodiment of the invention with reference to the figures, in which:

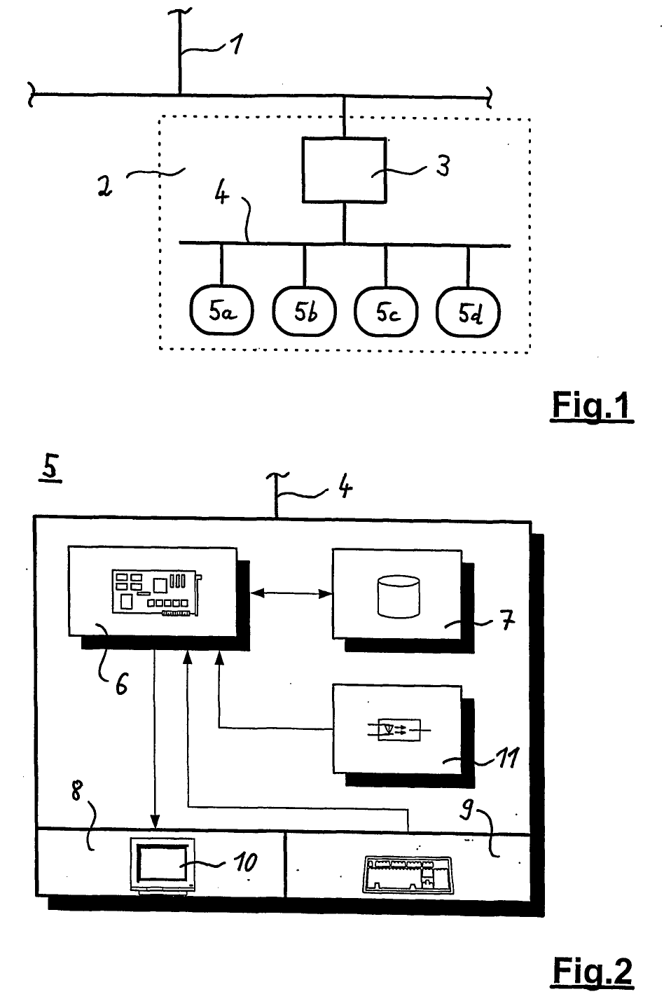

FIG. 1 shows the basic structure of a field bus system having a plurality of field devices containing the device according to the invention;

FIG. 2 shows a schematic diagram of the basic structure of an electronic functional checking unit of the device according to the invention; and

FIG. 3 shows a flowchart illustrating the method of functional checking.

According to FIG. 1, a field bus system 2 is connected to a system bus 1 of an automated system. The field bus system 2 is connected to the superordinate system bus 1 via an input/output unit 3. In addition to the input/output unit 3, the field bus system 2 comprises a field bus 4, via which the input/output unit 3 communicates with a plurality of field devices 5a to 5c connected to the field bus 4.

In addition to the electronic functional units (known per se), according to FIG. 2 each field device 5 connected to the field bus 4 comprises an electronic functional checking unit 6 for functional checking of the field device 5 before the commissioning thereof. After installation and connection of the field device 5, the electronic functional checking unit 6 carries out a functional checking algorithm with regard to meeting relevant connection parameters. In said exemplary embodiment, the field device 5 is a flowmeter, the functional checking algorithm of which checks the connection parameters “inflow path”, “flow rate range”, “installation position” and the like. At the beginning of the functional checking algorithm, the electronic functional checking unit 6 checks here whether the field device 5 is actually installed and connected and thus operationally ready. Proceeding from this start condition, the functional checking algorithm described above is activated. The electronic functional checking unit 6 only permits commissioning of the field device 5 if all connection parameters to be checked by the functional checking algorithm are within permitted ranges.

The defined permitted ranges of the connection parameters are stored within the field device 5 in a storage unit 7 assigned to the electronic functional checking unit 6. The storage unit 7 also serves to retrievably store the result of the functional checking algorithm executed by the electronic functional checking unit 6 therein. The storage unit 7 thus communicates bi-directionally with the electronic functional checking unit 6.

The field device 5 is furthermore equipped with display means 8 in the form of an LCD display, by means of which, if the result of the functional checking algorithm is negative, the electronic functional checking unit 6 notifies the user about the respective incorrect connection parameters that possibly led to release of the field device 5 being withheld. In this case, the display means 8 additionally provide information about measures for rectifying the error.

The field device 5 is also equipped with input means 9 in the form of a keyboard. Said input means 9 are used, in conjunction with the display means 8, by the user to enter the operative connection parameters that serve as input data for the functional checking algorithm of the functional checking unit 6. For this purpose, the display means 8 comprise menu-driven dialog means 10 which are designed in the form of a graphical user interface and can be displayed on the LCD display. In addition to said user-dependent acquisition of input data for the functional checking algorithm, connection parameters can also be determined here using sensor means 11 in order to execute part of the functional checking algorithm in a user-independent manner. For instance, the flow rate of the medium flowing through the flowmeter is measured by the sensor means 11.

### LIST OF REFERENCE NUMERALS

1 System bus
2 Field bus system
3 Input/output unit
4 Field bus
5 Field device
6 Functional checking unit
7 Storage unit
8 Display means
9 Input means
10 Dialog means
11 Sensor means

1. A method for functional checking of a field device (5) in a field bus system (2), before the commissioning thereof, wherein, after installation and connection of the field device (5), a functional checking algorithm is carried out with regard to meeting relevant connection parameters, whereby commissioning of the field device (5) is only permitted when all connection parameters to be checked by the functional checking algorithm are within permitted ranges.

2. The method for functional checking as claimed in claim 1, wherein it is determined at the beginning of the functional checking algorithm whether the field device (5) is installed and connected and thus operationally ready.

3. The method for functional checking as claimed in claim 1, wherein the functional checking algorithm is automatically initiated after installation and connection of the field device (5).

4. The method for functional checking as claimed in claim 1, wherein the permitted ranges of the connection parameters defined during the manufacturing process of the field device (5) are stored herein.

5. The method for functional checking as claimed in claim 1, wherein the result of the functional checking algorithm is retrievably stored in the field device (5).

6. The method for functional checking as claimed in claim 1, wherein if the result of the functional checking algorithm is negative, the user is notified about the incorrect connection parameters that led to release of the field device (5) being withheld.

7. The method for functional checking as claimed in claim 6, wherein, together with said information, additional help information for rectifying the incorrect connection parameters is output.

8. The method for functional checking as claimed in claim 1, wherein if the result of the functional checking algorithm is negative, release of the field device is permitted only manually by the user in order to nevertheless commission said field device.

9. The method for functional checking as claimed in claim 1, wherein the functional checking algorithm is performed by the field device (5) in the form of a menu-driven dialog with a user, in which the user is prompted to enter the operative connection parameters.

10. The method for functional checking as claimed in claim 1, wherein the functional checking algorithm is performed in the form of a user-independent process in the field device (5), in which the field device (5) determines the operative connection parameters by means of suitable sensor means.

11. A device for functional checking of a field device (5) in a field bus system (2), before the commissioning thereof, wherein, after installation and connection of the field device (5), an electronic functional checking unit (6) executes a functional checking algorithm with regard to meeting relevant connection parameters, whereby the electronic functional checking unit (6) only permits commissioning of the field device (5) when all connection parameters to be checked by the functional checking algorithm are within permitted ranges.

12. The device for functional checking as claimed in claim 11, wherein the electronic functional checking unit (6) determines at the beginning of the functional checking algorithm whether the field device (5) is installed and connected and thus operationally ready.

13. The device for functional checking as claimed in claim 11, wherein the permitted ranges of the connection parameters defined during the manufacturing process of the field device (5) are stored in a storage unit (7) assigned to the electronic functional checking unit (6).

14. The device for functional checking as claimed in claim 11, wherein the electronic functional checking unit (6) retrievably stores the result of the functional checking algorithm in the storage unit (7) of the field device (5).

15. The device for functional checking as claimed in claim 11, wherein if the result of the functional checking algorithm is negative, the electronic functional checking unit (6) notifies the user via display means (8) about the incorrect connection parameters that led to release of the field device (5) being withheld.

16. The device for functional checking as claimed in claim 11, wherein the display means (8) outputs additional help information for rectifying the incorrect connection parameters.

17. The device for functional checking as claimed in claim 11, wherein the electronic functional checking unit (6) is connected manually to input means (9) that can be operated manually by the user, the operation of which in the case where the result of the functional checking algorithm is negative initiates a manual release of the field device (5) in order to nevertheless commission said field device.

18. The device for functional checking as claimed in claim 11, wherein the electronic functional checking unit (6) has menu-driven dialog means (10) for prompting the user to enter the operative connection parameters in order to execute the functional checking algorithm in a user-dependent manner.

19. The device for functional checking as claimed in claim 11, wherein the electronic functional checking unit (6) has integrated sensor means (11) that determine the operative connection parameters in order to execute the functional checking algorithm in a user-independent manner.

20. A field device (5) for a field bus system (2), comprising a device for functional checking before commissioning as claimed in claim 11.

21. A software program product for carrying out a method for functional checking of a field device in a field bus system, before the commissioning thereof, wherein, after installation and connection of the field device, a functional checking algorithm is carried out with regard to meeting relevant connection parameters, whereby commissioning of the field device is only permitted when all connection parameters to be checked by the functional checking algorithm are within permitted ranges, and wherein a software program is executed by the electronic functional checking unit (6) of the device as claimed in claim 11.

22. The method for functional checking as claimed in claim 2, wherein the functional checking algorithm is automatically initiated after installation and connection of the field device.

23. A software program product for carrying out a method for functional checking of a field device in a field bus system, before the commissioning thereof, wherein, after installation and connection of the field device, a functional checking algorithm is carried out with regard to meeting relevant connection parameters, whereby commissioning of the field device is only permitted when all connection parameters to be checked by the functional checking algorithm are within permitted ranges, and wherein a software program is executed by the electronic functional checking unit of the device as claimed in claim 12.
